(19) United States
(12) Patent Application Publication
(10) Pub. No.: US 2018/0336528 A1
(43) Pub. Date: Nov. 22, 2018

(54) METHODS AND APPARATUS FOR SCREENING JOB CANDIDATES USING A SERVER WITH DYNAMIC REAL-TIME CONTEXT

(71) Applicant: HYPHENAI LLC, IRVINE, CA (US)

(72) Inventors: Mark Carpenter, Irvine, CA (US); Carlos Portela, Pompano Beach, FL (US)

(21) Appl. No.: 15/598,287

(22) Filed: May 17, 2017

(51) Int. Cl. G06Q 10/10; G06F 17/30; G06N 99/00

(52) U.S. Cl. CPC G06Q 10/1053; G06F 17/30663; G06F 17/30675; G06F 3/0484; G06F 17/30625; G06F 17/30887; G06N 99/005; G06F 17/30684

(57) ABSTRACT

A server is used to screen a job candidate. An indication is received that an interview interface has been activated by a client device. A first question of a plurality of questions stored in a memory of the server is sent to the client device for access by the job candidate via the interview interface. A first response to the first question is received from the client device, and the first response is evaluated in real-time using the server before sending a second question of the plurality of questions to the client device for access by the job candidate via the interview interface.

### BACKGROUND

Recruiters and human resources personnel are often inundated with numerous job applicants or candidates for an open position. Recruiters may spend, for example, forty hours just screening or narrowing down an initial pool of job candidates to identify a subset of candidates to be interviewed. During the screening process, many of the candidates may be removed from the initial pool of candidates for not meeting qualifications or requirements for the position, such as a minimum level of experience or education, or for other reasons such as not being willing to travel or relocate, or expecting a higher salary.

Although recent advancements have allowed for electronically searching candidate resumes or applications, such automated searching may miss other relevant terms and fail to provide more detailed, current, or relevant information about candidates during the screening process. In some cases, search terms found in a candidate's resume or job application may be taken out of context and may not be relevant. For example, a resume may mention a particular skill, but the candidate may not have practiced the skill in many years. In other cases, information about a promising candidate may be missed because of the inability to recognize variations of a particular search term or the inability to ask follow up questions during the initial screening process, especially when screening a large number of job candidates.

### BRIEF DESCRIPTION OF THE DRAWINGS

The features and advantages of the embodiments of the present disclosure will become more apparent from the detailed description set forth below when taken in conjunction with the drawings. The drawings and the associated descriptions are provided to illustrate embodiments of the disclosure and not to limit the scope of what is claimed.

FIG. 1 shows an example environment for screening job candidates according to an embodiment.

FIG. 2 shows an example subset of campaign data according to an embodiment.

FIG. 3 shows an example of interview data for the subset of the campaign data of FIG. 2 according to an embodiment.

FIG. 4 shows an example subset of candidate data according to an embodiment.

FIG. 5 is a diagram showing a server implementation environment according to an embodiment.

FIG. 6 is a flowchart for a campaign creation process according to an embodiment.

FIG. 7 is an example of a user interface for a job builder module according to an embodiment.

FIG. 8 is an example of a user interface for a campaign manager module according to an embodiment.

FIG. 9 is a flowchart for a virtual interview building process according to an embodiment.

FIG. 10 is an example of a user interface representing a tree structure for a virtual interview according to an embodiment.

FIG. 11 is an example of a user interface for a question node of a virtual interview according to an embodiment.

FIG. 12 is a flowchart for a virtual interview process according to an embodiment.

FIG. 13 is a flowchart for displaying a question including possible response buttons and a free-form text field at a client according to an embodiment

FIG. 14 is an example of an interview interface displayed at a candidate device according to an embodiment.

FIG. 15 is a flowchart for a scoring and ranking process according to an embodiment.

FIG. 16 is an example of a user interface for an analytic and ranking module according to an embodiment.

### DETAILED DESCRIPTION

In the following detailed description, numerous specific details are set forth to provide a full understanding of the present disclosure. It will be apparent, however, to one of ordinary skill in the art that the various embodiments disclosed may be practiced without some of these specific details. In other instances, well-known structures and techniques have not been shown in detail to avoid unnecessarily obscuring the various embodiments.

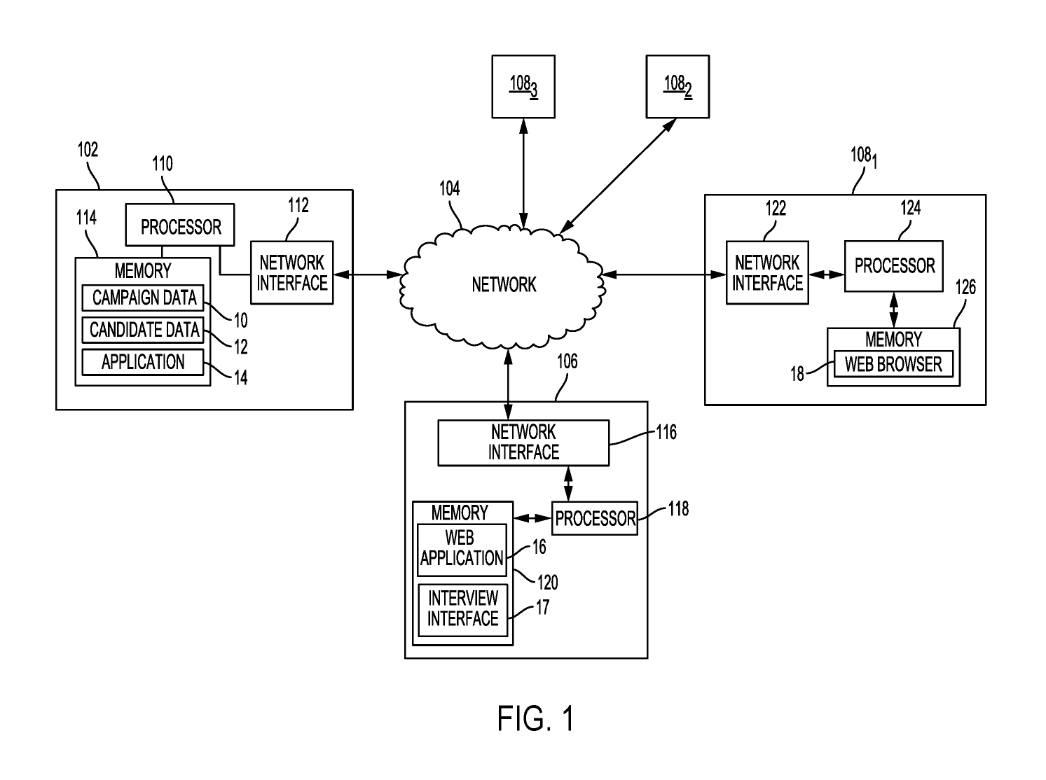

FIG. 1 shows an example environment for screening job candidates according to an embodiment. As shown in FIG. 1, server 102, client device 106, and candidate devices 108₁, 108₂, and 108₃ are each connected to network 104. Network 104 may include, for example, a wide area network, such as the Internet.

Server 102 includes processor 110, network interface 112, and memory 114. In the implementation of FIG. 1, memory 114 stores campaign data 10, candidate data 12, and application 14. Processor 110 can include circuitry such as one or more processors or a Central Processing Unit (CPU) for executing instructions and can include a sever processor, microcontroller, a Digital Signal Processor (DSP), an Application Specific Integrated Circuit (ASIC), a Field Programmable Gate Array (FPGA), hard-wired logic, analog circuitry and/or a combination thereof.

Network interface 112 can include one or more network interface cards to allow server 102 to communicate on network 104 using a standard such as Ethernet and/or Fibre Channel. In some implementations, network interface 112 may be combined with processor 110.

Memory 114 can include one or more non-volatile storage devices such as, for example, one or more hard disk drives and/or solid state drives. In addition, memory 114 can include a random access memory such as Dynamic Random Access Memory (DRAM) or a non-volatile random access memory for temporarily storing data to be used by processor 110, such as instructions loaded from a non-volatile memory of memory 114 for execution by processor 110 as needed. In some implementations, such random access memory may be combined with processor 110.

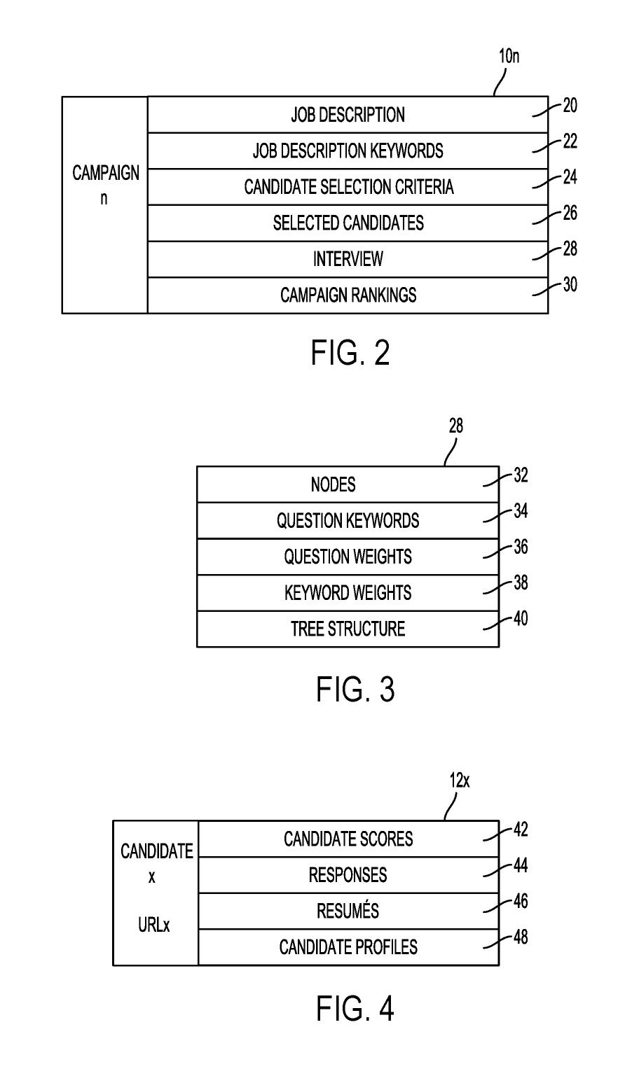

As shown in FIG. 1, memory 114 can store campaign data 10, candidate data 12, and application 14. As discussed in more detail below with reference to FIGS. 2 and 3, campaign data 10 can include information about hiring campaigns for current and/or past open job positions. Candidate data 12 can include information about job candidates, as discussed below in more detail with reference to FIG. 4. In some implementations, campaign data 10 and candidate data 12 can be managed by server 102 using application 14 executed by processor 110.

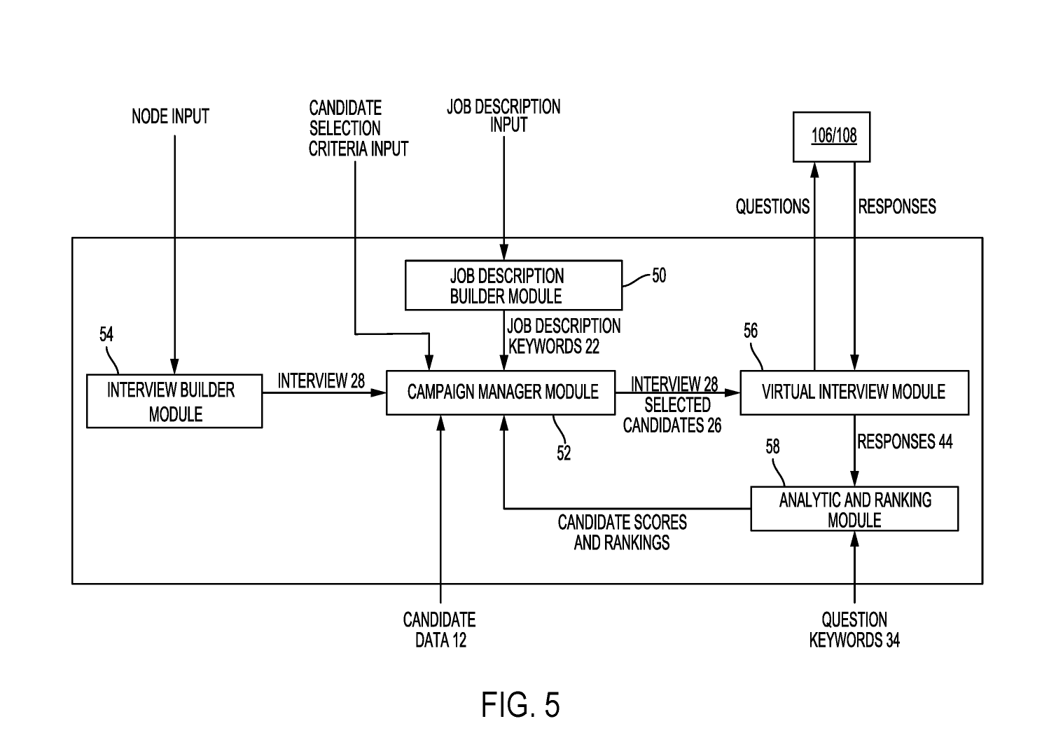

Application 14 can include various modules for building a job description, building a virtual interview, managing a hiring campaign, interviewing a job candidate, and analyzing and ranking job candidates based on their interviews. An example implementation of application 14 is discussed in more detail below with reference to FIG. 5.

In the example environment of FIG. 1, client device 106 can include, for example, a web server of a recruiter that is conducting a hiring campaign to fill an open position for a customer. In other examples, client device 106 can include a web server of a company that is conducting an in-house hiring campaign to fill an open position at the company. Client device 106 includes network interface 116, processor 118, and memory 120. As will be appreciated by those of ordinary skill in the art, an understanding of network interface 116, processor 118, and memory 120 can be obtained with reference to the descriptions of similarly named components of server 102 discussed above.

Memory 120 of client device 106 stores web application 16, which can be used to serve a web page to candidate devices 108₁, 108₂, and 108₃ and execute interview interface 17. In this regard, interview interface 17 may activate when web browser 18 or a messaging application (e.g., a texting application or Facebook's messenger application) executing on candidate device 108₁ accesses the web page via a hyperlink including a unique run identifier.

Candidate devices 108₁, 108₂, and 108₃ can include a personal computer or a portable electronic device operated by one or more job candidates, such as a laptop, tablet, or smartphone, for example. In the example of FIG. 1, candidate device 108₁ is shown in more detail than candidate devices 108₂ and 108₂, but each candidate device 108 in FIG. 1 is to be understood to include components corresponding to network interface 122, processor 124, and memory 126 of candidate device 108₁. Those of ordinary skill in the art will appreciate that other examples can include a different number of candidate devices 108 than those shown in FIG. 1.

Network interface 122 of candidate device 108₁ can include a network interface card or other circuitry to allow candidate device 108₁ to communicate on network 104 using a standard such as Ethernet and/or WiFi. In some implementations, network interface 122 may be combined with processor 124.

Processor 124 of candidate device 108₁ can include circuitry such as one or more processors or a Central Processing Unit (CPU) for executing instructions and can include a processor, microcontroller, a Digital Signal Processor (DSP), an Application Specific Integrated Circuit (ASIC), a Field Programmable Gate Array (FPGA), hard-wired logic, analog circuitry and/or a combination thereof. In some implementations, processor 124 can include a System on a Chip (SoC) that may combine the circuitry of processor 124 with network interface 122 and/or memory 126.

Memory 126 of candidate device 108₁ can include one or more non-volatile storage devices such as, for example, a hard disk drive or a solid-state drive. In addition, memory 126 can include a random access memory such as Dynamic Random Access Memory (DRAM) or a non-volatile random access memory for temporarily storing data to be used by processor 124, such as instructions loaded from a non-volatile memory of memory 124 for execution by processor 126 as needed. In some implementations, such random-access memory may be combined with processor 124.

As will be appreciated by those of ordinary skill in the art, other embodiments may include a different arrangement of components than those shown in the example of FIG. 1. For example, in some embodiments, candidate device 108₁ may act as a client device by storing interview interface 17 in memory 126 of candidate device 108₁ for execution by processor 124. Such embodiments may not include client device 106 as a web server, and candidate device 108₁ would then be considered to be the client device to server 102. In one example, a text messaging application executed by candidate device 108₁ may communicate directly with server 102. In yet another example, a third-party messaging server for a messaging application executed by candidate device 108₁ may communicate with server 102 without the need for a web page served by client device 106. In another implementation, interview interface 17 may be executed by processor 110 of server 102 and accessed by candidate device 108₁. In yet another implementation, campaign data 10 and/or candidate data 12 may be stored in a storage location remote from server 102.

FIG. 2 shows an example subset of campaign data 10 according to an embodiment. In this regard, campaign data 10ₙ includes a subset of information about a particular campaign n from among a larger set of campaign data 10 for multiple campaigns to fill multiple job positions. As shown in FIG. 2, campaign data 10ₙ includes job description 20, job description keywords 22, candidate selection criteria 24, selected candidates 26, interview 28, and campaign rankings 30 for a particular campaign n. Each campaign in the larger set of campaign data 10 may include a similar subset of information.

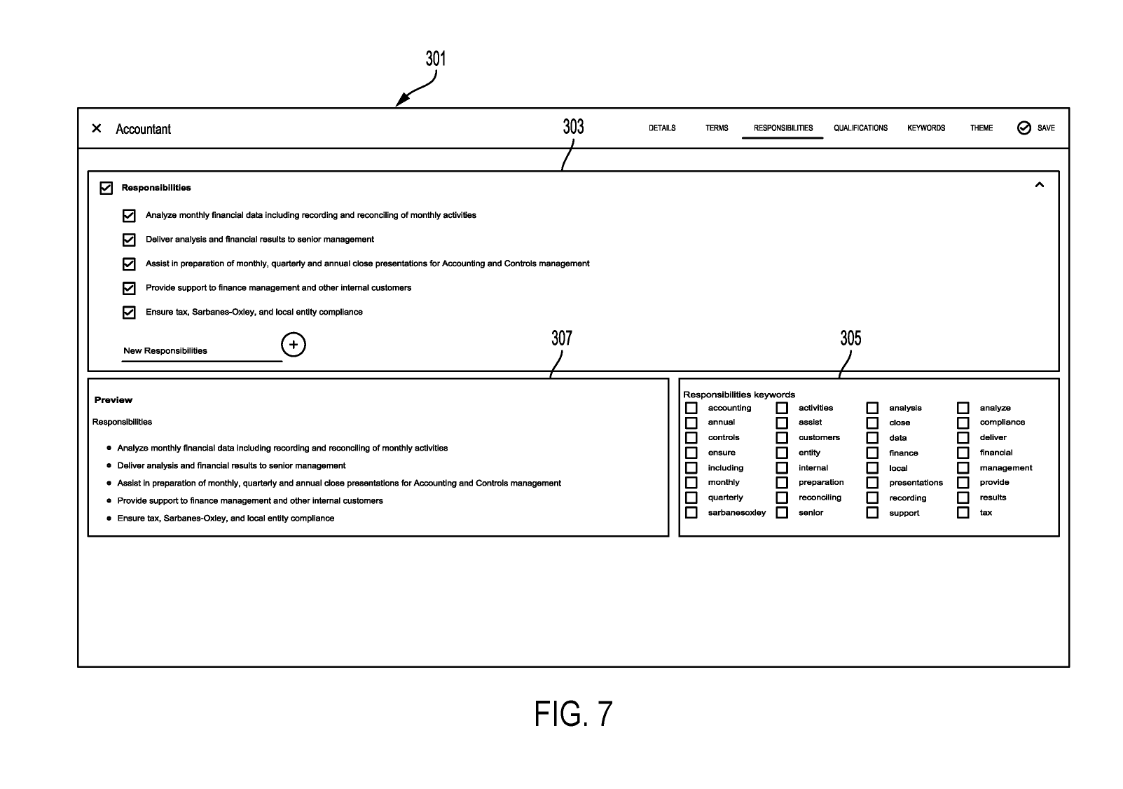

Job description 20 can include text provided by, for example, a recruiter or a hiring manager via a user interface of application 14 to describe an open position for the hiring campaign. An example of a job description can include, for example, job responsibilities and related tasks, background information on the employer, compensation offered, and/or required or preferred qualifications. An example of a portion of a job description is shown in FIG. 7 with the job responsibilities shown in preview 307 of user interface 301 for a job builder module (e.g., job builder module 50 in FIG. 5) of application 14.

Returning to FIG. 2, job description keywords 22 can include particular portions or related terms of job description 20 that can be used by a campaign manager module (e.g. campaign manager 52 of FIG. 5) of application 14 to identify candidates to interview during a campaign creation process. For example, processor 110 may parse candidate profiles and/or resumes included in candidate data 12 to match job description keywords 22 with text included in the candidate profiles and/or resumes. In some implementations, this may allow for the identification of job candidates who may not have applied for the particular job to be filled by the hiring campaign since previously submitted candidate profiles and resumes can be searched or parsed in matching job description keywords.

The matching may be performed using Artificial Intelligence (AI) such as Natural Language Processing (NLP) and/or Machine Learning (ML) to better identify terms in the candidate profiles and resumes that relate or correspond to job description keywords 22. In the case of NLP, processor 110 may use string processing, part-of-speech tagging, parsing, string classification, semantic interpretation, evaluation metrics, and/or probability estimation to identify likely word form variations, alternative vocabulary, and/or misspellings in the candidate profiles and resumes. In the case of ML, processor 110 can use previous searches for the same or similar job description keywords from the same and/or other campaigns to train the NLP to identify new word form variations, new alternative vocabulary, and/or new misspellings in the candidate profiles and resumes.

By using AI to match candidate provided information with job description keywords, it is ordinarily possible to better identify candidates that are worth interviewing. In addition, NLP and/or ML can also be used by processor 110 to suggest or generate job description keywords to be used when initially searching candidate data 12 for job candidates to interview.

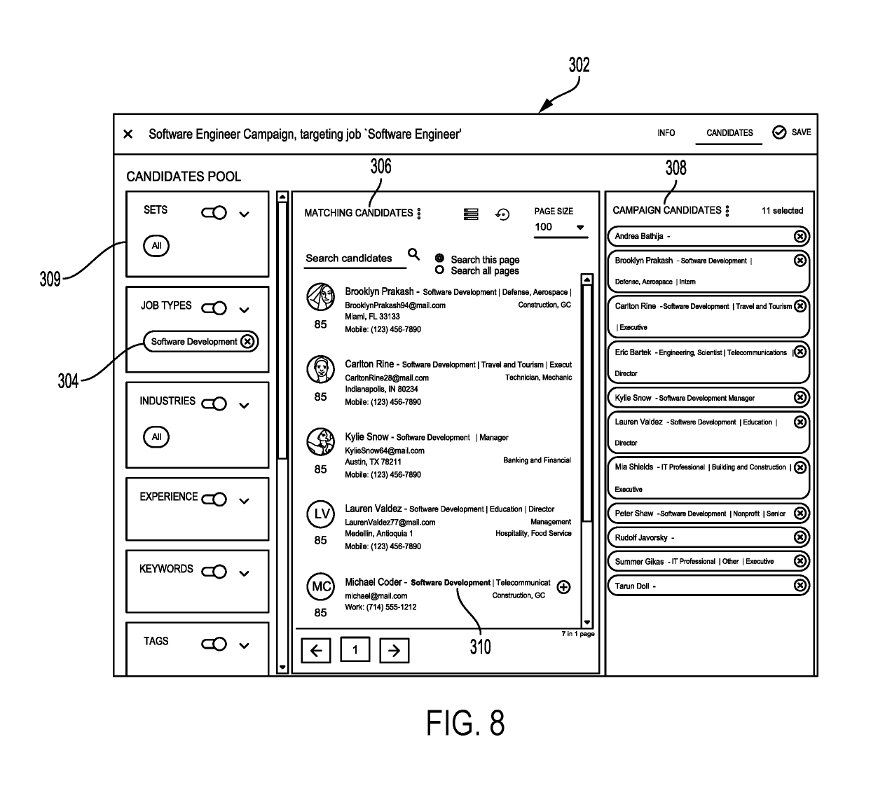

Candidate selection criteria 24 includes criteria defined by a user (e.g., a recruiter or hiring manager) via a user interface of application 14 for selecting candidates to interview. Such criteria may include, for example, parameters such as a number or percentage of candidates to virtually interview using server 102, such as twenty candidates with the most matches to job description keywords in their candidate profiles and/or resumes. Other examples of candidate selection criteria 24 can include criteria such as a minimum level of experience, a minimum education level, or a certification requirement. As discussed below in more detail with the example user interface of FIG. 8, filters may be applied by the user as part of candidate selection criteria 24 to exclude and/or rank job candidates.

Selected candidates 26 can include a list of candidates who have been selected for being virtually interviewed by server 102 based on their ranking in matching job description keywords 22 and the candidate selection criteria 24. In some implementations, selected candidates 26 may be manually selected by a user (e.g., a recruiter or hiring manager) via a user interface of application 14. In this regard, selected candidates 26 may be a subset of matching candidates identified by processor 110 based on the matching of job description keywords 22 to terms found in candidate profiles and/or resumes.

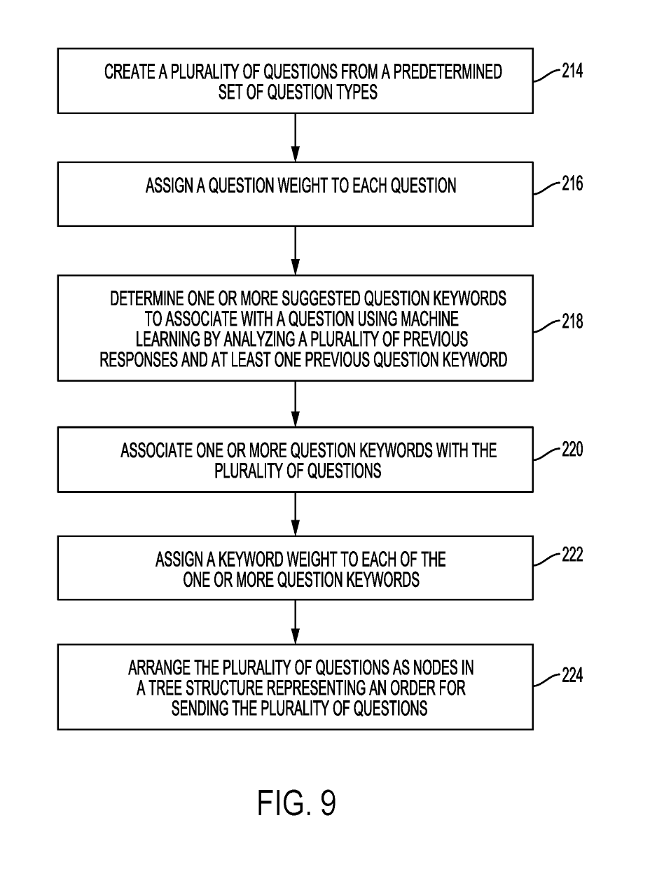

Interview 28 can include question nodes and statement nodes defined or arranged by a user during a virtual interview building process, such as the example process of FIG. 9 discussed below. The question nodes and statement nodes include questions and statements, respectively, that are sent to client device 106 during a virtual interview for access by a candidate device 108 via interview interface 17. As noted above, other implementations may include server 102 sending questions and statements directly to a candidate device 108 acting as the client device in situations where interview interface 17 is executed by candidate device 108 instead of by client device 106.

Campaign rankings 30 can include a dynamic representation of scores and/or a ranking of a job candidate relative to other job candidates selected for campaign n. As discussed in more detail below, an analytic and ranking module of application 14 (e.g., analytic and ranking module 58 in FIG. 5) may allow for the scoring and/or ranking of job candidates in real-time as questions are answered by job candidates to provide a current scoring and/or ranking of job candidates for a user interface of application 14.

FIG. 3 shows an example of interview data 28ₙ for the subset of campaign data 10ₙ of FIG. 2 according to an embodiment. As shown in FIG. 3, interview data 28ₙ includes nodes 32, question keywords 34, question weights 36, keyword weights 38, and tree structure 40.

Nodes 32 can include questions and/or statements created by a user (e.g., a recruiter or hiring manager) via a user interface of application 14 during a virtual interview creation process. As described in more detail below with reference to FIG. 9, the questions and statements for interview 28 can be selected from a predetermined set of question types such as a yes/no Boolean question type, a single response question type, a multiple response question type, a ranking question type, and a free-form text response question type. In some implementations, a user may create questions and statements via a user interface for a virtual interview builder module of application 14, which may provide suggested fields for creating the question or statement.

Question keywords 34 can include keywords associated with questions of nodes 32. Question keywords 34 may be manually added by a user (e.g., a recruiter of hiring manager) via a user interface for the virtual interview builder module and/or processor 110 may automatically suggest question keywords to be associated with a question using ML to analyze a plurality of previous responses and at least one previous question keyword stored in campaign data 10. The plurality of previous responses may be received from different job candidates in response to one or more previous similar questions not included in interview 28. The use of ML to suggest or generate question keywords can ordinarily allow for a more robust set of question keywords 34 to better match question keywords to job candidate responses. This in turn can make the virtual interview process more useful and help reduce instances of failing to account for an otherwise relevant or significant candidate response.

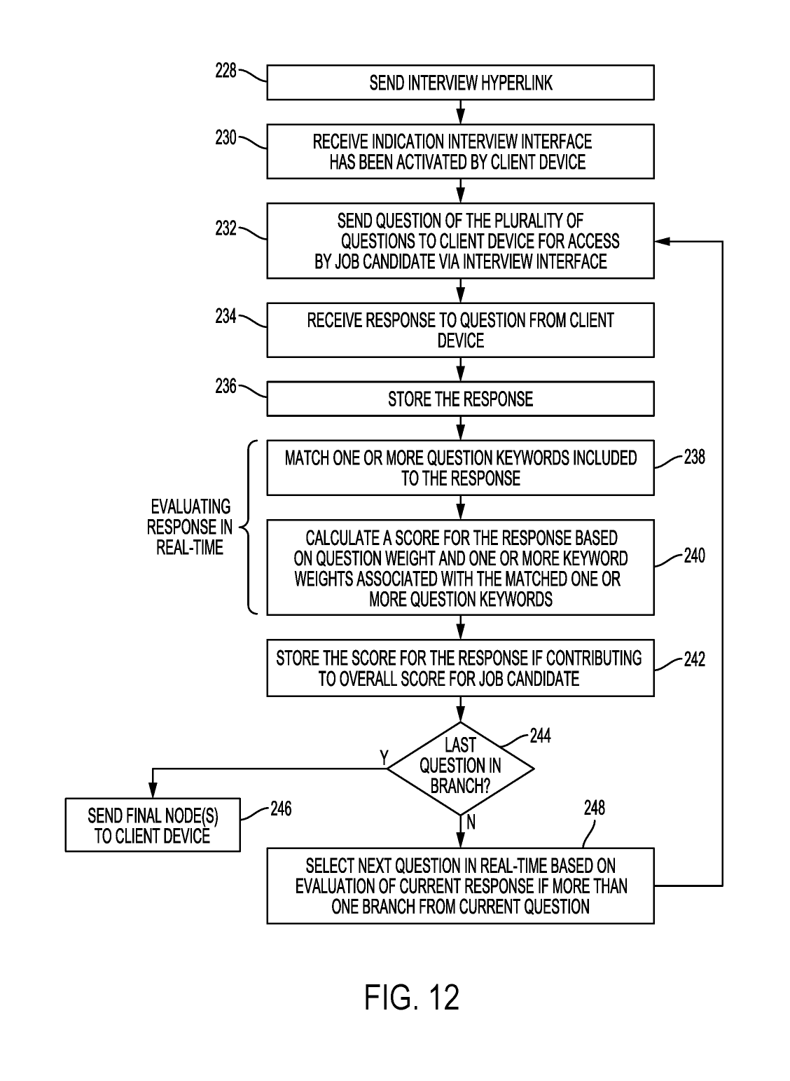

Question weights 36 include weight values assigned by a user via a user interface of application 14 to the questions included in interview 28. This can ordinarily allow for customization during the virtual interview building process to place more emphasis on certain questions over others. As discussed in more detail below with reference to the virtual interview process of FIG. 12, question weights 36 can be used with keyword weights 38 to calculate a score for a candidate's response to a question in real-time.

In some implementations, certain questions may be assigned a question weight of zero so that the response to the question does not contribute to a score for the job candidate. Questions with a zero question weight may include, for example, whether the job candidate's contact information has changed or questions that may be used to lead to a more focused question that is assigned a non-zero weight.

Keyword weights 38 include weight values assigned by a user via a user interface of application 14 to question keywords 34. This can ordinarily allow for further customization during the virtual interview building process to provide more credit or weight to certain responses over others. This additional granularity in the scoring of individual responses can ordinarily provide a more thorough and meaningful comparison of job candidates during the screening process as compared to a more binary scoring of responses.

As discussed in more detail below with reference to the virtual interview process of FIG. 12, keyword weights 38 may be used with question weights 36 to calculate a score in real-time for a job candidate's response to a question based on a matching or approximate matching of question keywords 34 to a job candidate's response. The matching of question keywords 34 to a job candidate's response may also include deriving a question keyword from a variation of the question keyword in the job candidate's response. In this regard, processor 110 may use NLP to identify the variation of the question keyword in the response. In some implementations, the NLP may be trained using ML from previous responses from different job candidates for the same or related question keywords.

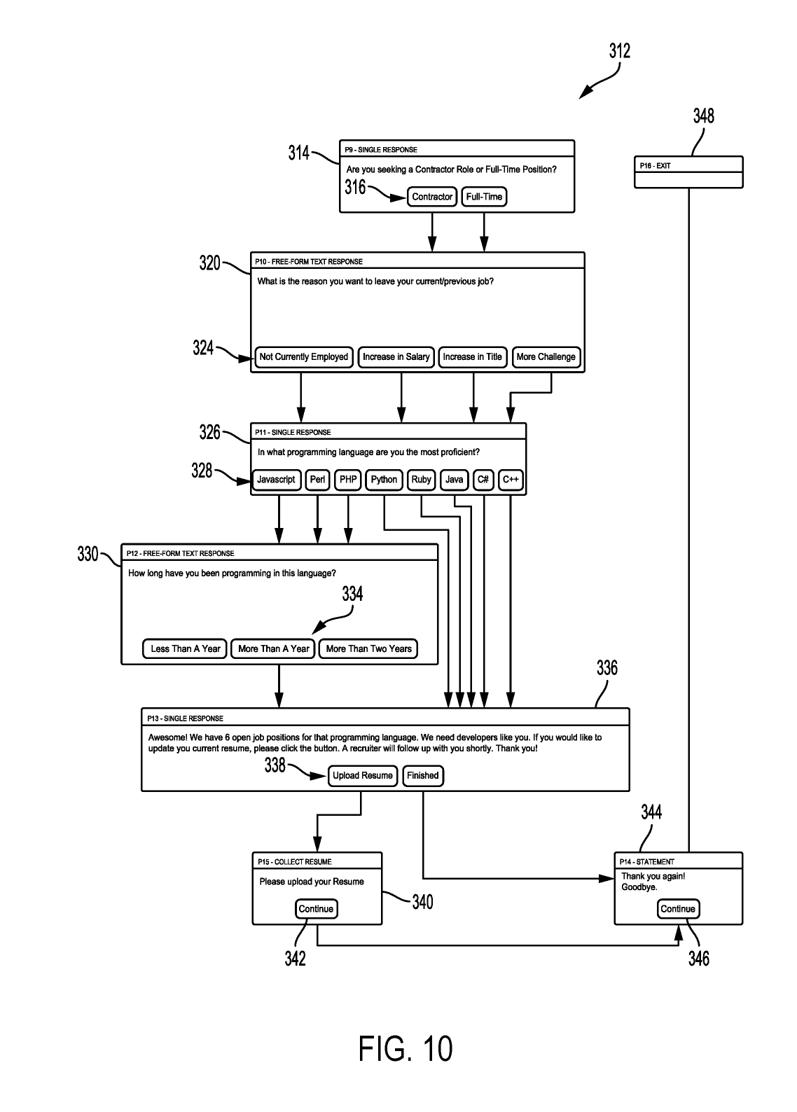

Tree structure 40 includes an arrangement of nodes 32 representing an order for presenting questions and statements to the job candidate via an interview interface. A user may determine the order for tree structure 40 via a user interface for a virtual interview builder module of application 14. An example of such a tree structure is shown in the virtual interview builder user interface example of FIG. 10 where the path to a next question or statement may be determined based on a real-time evaluation of a current response received from client device 106 or candidate device 108.

FIG. 4 shows an example of a subset of candidate data 12ₓ for a particular job candidate x according to an embodiment. In the example of FIG. 4, the subset of candidate data 12ₓ includes candidate scores 42, responses 44, resumes 46, and candidate profiles 48 collected for job candidate x. In some implementations, the candidate data for each job candidate can be associated with the job candidate using a unique identifier, such as a unique Uniform Resource Locator (URL) that points to the candidate data for the job candidate.

Candidate scores 42 can include can include individual scores for particular responses provided by the job candidate and an overall current score for the job candidate based on multiple scores for different questions. In one implementation, the overall score for a job candidate can be calculated by processor 110 using an analytics and ranking module of application 14. A score for a candidate response may be calculated in real-time during a virtual interview session before sending a next question or a next statement to client device 106 or candidate device 108 by multiplying a question weight times a total keyword weight for the job candidate's response. The total keyword weight can, for example, include a summation of individual keyword weights for question keywords 34 found to match or approximately match terms found in the job candidate's response.

Responses 44 include responses collected from the job candidate during one or more virtual interview sessions. In this regard, responses 44 may be from a single hiring campaign or from multiple hiring campaigns. In some implementations, responses for multiple job candidates can be used by ML algorithms of application 14 to identify patterns or variations of question keywords in job candidate responses to improve the ability of application 14 to suggest related question keywords in the interview builder module or to identify terms substantially related to a question keyword in a job candidate response during a virtual interview.

Resumes 46 include one or more resumes submitted by the job candidate. In this regard, resumes 46 may include different versions of resumes submitted by the job candidate in applying for different open positions or hiring campaigns. This can ordinarily provide a more thorough initial screening of a large candidate pool for various hiring campaigns, such as when attempting to find job description keywords in job candidate resumes.

Candidate profiles 48 can include information submitted by a job candidate when applying for a position or in managing their profile via candidate device 108. For example, candidate profile 48 may include information such as contact information or basic information about the candidate such as an industry or a residence location that the job candidate may have provided via a user interface of application 14.

FIG. 5 is a diagram showing a server implementation environment for application 14 according to an embodiment. As shown in the example of FIG. 5, application 14 can include job description builder module 50, campaign manager module 52, interview builder module 54, virtual interview module 56, and analytic and ranking module 58. The modules of application 14 may use a Structured Query Language (SQL) to access, share, and modify data stored in memory 114, such as campaign data 10 and candidate data 12. In this regard, the passing of data from one module to another in FIG. 5 may include one module storing the data in memory 114 and another module retrieving the data from memory 114. In addition, other implementations of application 14 may include a different set of modules for application 14 than those shown in FIG. 5. For example, different implementations may combine certain modules or use separate applications to serve the functions of the modules shown in FIG. 5.

In operation, job description builder module 50 receives a job description input via a user interface. The job description input is used to form job description 20 stored in campaign data 10, as discussed above with reference to FIG. 2. The job description input can include text describing an open position and/or a selection of predetermined job descriptions provided by job description builder module 50.

Job description builder module 50 can extract and/or derives job description keywords 22 from the job description input. In some implementations, job description builder module 50 may dynamically extract job description keywords as the job description input is received via the user interface, and present the job description keywords to a client device for selection by a user. The creation of job description keywords may involve matching a predetermined list of job description keywords stored in memory 114 to the job description input. In some implementations, job description builder module 50 may use NLP and/or ML to suggest variations or related job description keywords derived from the job description input and candidate pool filtering in previous campaigns using the same or similar job descriptions or job description keywords. An example of suggested job description keywords is shown in FIG. 7 in the responsibilities keywords area 305 of user interface 301 for job description builder module 50. As shown in the example of FIG. 7, a user can select or unselect suggested job description keywords in user interface 301.

Returning to FIG. 5, job description builder module 50 provides campaign manager module 52 with job description keywords 22 to allow campaign manager module 52 to parse or search information submitted by job candidates (e.g., resumes and candidate profiles). Campaign manager module 52 accesses candidate data 12 to find terms matching and/or relating to job description keywords 22. As discussed above, campaign manager module 52 may use NLP and ML to identify variations of job description keywords 22 or terms related to job description keywords 22 in candidate information.

Campaign manager module 52 may dynamically track or update a keyword count indicating a number of matching and/or related terms found for different job candidates. In addition, campaign manager module 52 receives candidate selection criteria input via a user interface to allow for the filtering of a pool of job candidates. The candidate selection criteria input is stored as candidate selection criteria 24 in campaign data 10.

The matching and filtering performed by campaign manager module 52 may be enhanced in some implementations by allowing a user to create tags in addition to job description keywords 22 that campaign manager module 52 can use to perform further filtering of job candidates. An example of a user interface for campaign manager module 52 is provided in FIG. 8, which displays a list of matching candidates 306 after filtering job candidates using job description keywords and tags. The filtering provided by campaign manager module 52 may be dynamic so that a user can change candidate selection criteria input using, for example, filtering controls 309 in FIG. 8, to dynamically change a set of selected candidates displayed in the interface, such as the list of selected candidates 308 shown in FIG. 8.

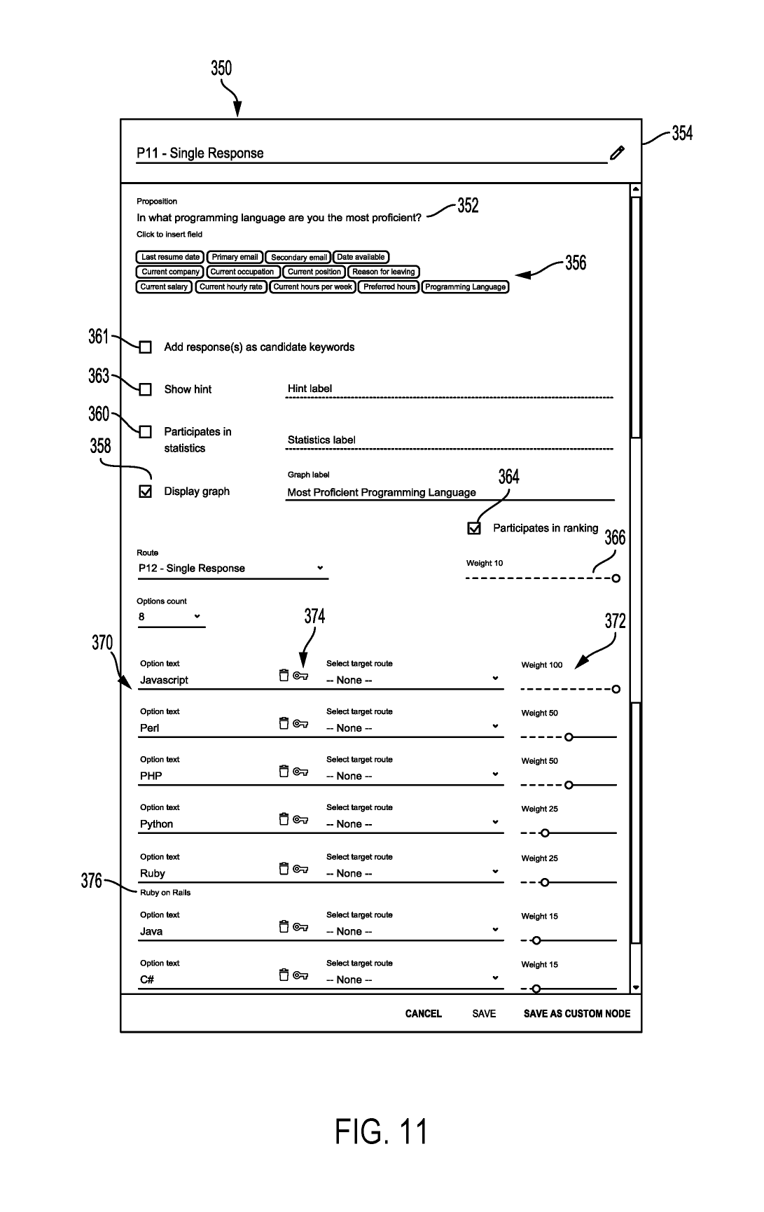

Returning to FIG. 5, interview builder module 54 of application 14 also receives node input via a user interface of interview builder module 54. Node input can include questions and statements to be included in interview 28. In addition, node input can include question keywords, question weights, and keyword weights selected by a user. As discussed in more detail below with reference to FIGS. 9 to 11, interview builder module 54 can allow a user to create questions for a virtual interview from a predetermined set of question types, such as a yes/no Boolean question type, a single response question type, a multiple response question type, a ranking question type, and a free-form text response question type. A user interface of interview builder module 54 may allow a user to add a question weight (e.g., question weight 366 in FIG. 11) for each question and a keyword weight (e.g., one of keyword weights 372 in FIG. 11) for each question keyword.

In some implementations, interview builder module 54 may use NLP and ML to suggest variations or related question keywords. The ML may be trained from previous campaigns and interview questions using the same or similar question keywords and their associated job candidate responses (e.g., responses 44) to automatically populate suggested question keywords for a question node in the user interface for interview builder module 54. In addition, the user interface for interview builder module 54 can allow for the arrangement of questions and statements into a tree structure representing an order for sending questions to client device 106 or a candidate device 108 with different paths depending on the responses to the questions. An example of such a tree structure is provided in FIG. 10 discussed in more detail below.

Returning to FIG. 5, interview builder module 54 uses the node input to create interview 28 for a particular campaign. Interview 28 is then passed from interview builder module 54 to campaign manager module 52. A user interface of campaign manager module 52 allows a user to select job candidates stored as selected candidates 26 to virtually interview as part of the screening process using virtual interview module 56. As shown in FIG. 5, campaign manager module 52 passes selected candidates 26 and interview 28 for the hiring campaign to virtual interview module 56 to virtually interview job candidates operating candidate devices 108.

Virtual interview module 56 may send an interview hyperlink via network interface 112. In some implementations, the interview hyperlink may include a run identifier for activating interview interface 17 on client device 106. In such implementations, the interview hyperlink may point to a web page (e.g., a virtual interview landing page) served by client device 106 using web application 16. Client device 106 may then activate interview interface 17 in response to a candidate device 108 accessing the web page via web browser 18.

After server 102 receives an indication from client device 106 that interview interface 17 has been activated, virtual interview module 56 proceeds with sending questions and statements to client device 106 following tree structure 40 for access by candidate device 108. In this regard, interview interface 17 can include a client interface enabling a dialog between server 102 and candidate device 108. Interview interface 17 may include, for example, a chatbot interface to provide a virtual interview where questions and statements are asked, the order of which depends on a real-time evaluation of responses from the job candidate.

In addition, virtual interface module 56 passes responses received from client device 106 (or candidate device 108 in implementations where interview interface 17 runs on candidate device 108) one at a time as they are received to analytic and ranking module 58 for real-time evaluation and scoring of the responses before sending a next question or statement. This real-time scoring and evaluation of responses can ordinarily allow for a more dynamic virtual interview process by selecting a proper path in tree structure 40 for follow up or more focused questions. In addition, the real-time evaluation and scoring of responses allows for a more current view or ranking of candidates that can be viewed by a user, such as a recruiter or hiring manager. For example, in some cases, a job candidate may only partially complete a virtual interview and may return to the virtual interview at a later time. A recruiter in such a scenario may still view a current ranking of candidates selected for virtual interviews including the scoring of the responses of a partially completed virtual interview or for interview that is in progress.

In evaluating job candidate responses, analytic and ranking module 58 accesses question keywords 34 to find keywords for the question that match the response. Analytic and ranking module 58 can use an AI engine including NLP and/or ML to better match question keywords used for scoring to a job candidate response. For example, analytic and ranking module 58 may match a question keyword to a response using NLP by identifying a variation of the question keyword or a term related to the question keyword in the response. Such keyword variations or related terms can include, for example, keyword misspellings, word form variations, or alternative vocabulary. Analytic and ranking module 58 may also use special character search strings (e.g., account*) for begins with, ends with, and contains when matching question keywords to responses. In addition, new keyword variations and new related terms may be added by analytics and ranking module 58 based on the evaluation of previous responses from different job candidates for previous campaigns and/or the current campaign. The ML may be trained using the same or similar question keywords and their corresponding job candidate responses.

Analytic and ranking module 58 provides campaign manager 52 with candidate scores and rankings for the job candidates for inclusion with candidate rankings 30 for the campaign. Analytic and ranking module 58 may provide an overall score or a current running score for a job candidate based on the scoring of individual responses. The scoring of individual responses may also be stored as responses 44 as part of candidate data 12. In other implementations, the scores for each response may also or alternatively be stored as part of campaign data 10.

Campaign manager module 52 may also allow a user to dynamically search and filter the selected candidates by rank or by more specific parameters, such as by finding all candidates who matched a particular question keyword for a question.

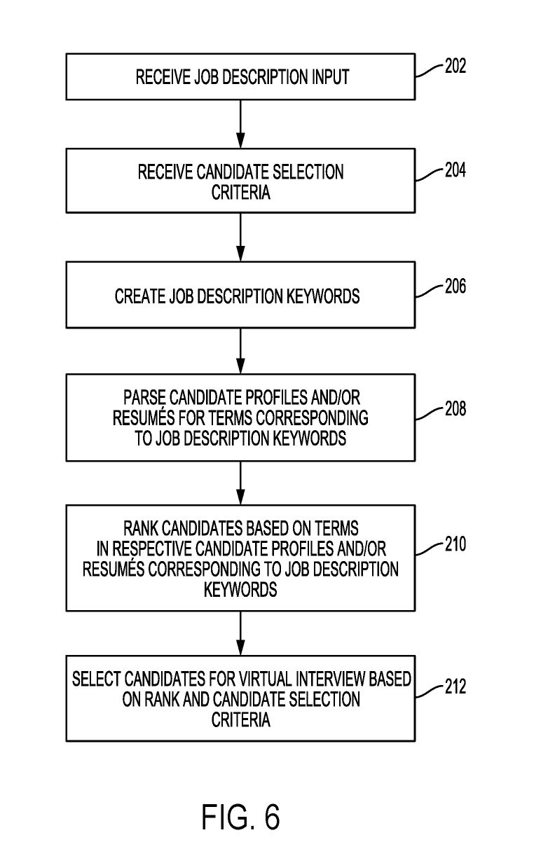

FIG. 6 is a flowchart for a campaign creation process that can be performed by processor 110 executing application 14 according to an embodiment. In block 202, processor 110 receives job description input via a user interface of job description builder module 50. As noted above, the job description input can include text describing an open position and/or a selection of predetermined job descriptions provided by job description builder module 50.

In block 204, processor 110 receives candidate selection criteria. The candidate selection criteria can include criteria defined by a user (e.g., a recruiter or hiring manager) for selecting candidates to interview as part of the screening process. Such criteria may include, for example, a final number of candidates to interview during the screening process, a minimum level of experience, a minimum education level, or a required certification.

In block 206, processor 110 creates job description keywords 22 based on the job description input received in block 202. Job description keywords 22 can include particular portions or related terms of job description 20 that can be used to identify selected candidates 26.

In block 208, processor 110 using campaign manager module 52 parses candidate profiles 48 and/or resumes 46 included in candidate data 12 to match job description keywords 22 with text included in the candidate profiles 28 and/or resumes 44. In some implementations, the matched text from candidate resumes may be stored as candidate keywords as part of candidate profiles 28. The parsing or searching in block 208 may allow for the identification of job candidates who may not have applied for the particular job to be filled by the hiring campaign since previously submitted candidate profiles and/or resumes can be searched or parsed for matching job description keywords.

As noted above, the matching may be performed using NLP and/or ML to better identify terms in the candidate profiles or resumes that relate to or correspond to job description keywords 22. By using AI to match candidate provided information with job description keywords, it is ordinarily possible to better identify promising job candidates to virtually interview.

In block 210, processor 110 ranks candidates based on terms in the candidate's respective candidate profiles and/or resumes corresponding to job description keywords 22. The ranking may, for example, be performed by comparing a total number of matching job description keywords for a job candidate to other job candidates.

In block 212, processor 110 selects candidates for a virtual interview based on the ranking performed in block 210 and the candidate selection criteria received in block 204.

FIG. 7 is an example of a user interface 301 for job description builder module 50 according to an embodiment. As shown in FIG. 7, user interface 301 includes a responsibilities creation box 303, a preview box 307, and responsibilities keywords area 305. A user of client device 106 can either add responsibilities by typing into a text field of responsibilities creation box 303 or select prepopulated responsibilities suggested by job description builder module 50 based on previous campaigns for similar job titles and/or industries. In addition, job description builder module 50 provides suggested job responsibility keywords in responsibilities keywords area 305 that can be based on the responsibilities added or selected in responsibilities creation box 303. The job responsibility keywords can be added or stored as job description keywords 22 after being selected. A similar user interface can be provided by job description builder module 50 for creating job description 20 and job description keywords 22 based on job qualifications, which in the example of FIG. 7, may be navigated to by selecting qualifications at the top of user interface 301.

FIG. 8 is an example of user interface 302 for campaign manager module 52 according to an embodiment. As shown in FIG. 8, user interface 302 includes a list of matching candidates 306 after filtering job candidates using job description job type, industry, experience, and keywords. In addition, filtering may also be performed using tags associated with candidate profiles. The filtering provided by campaign manager module 52 may be dynamic so that a user can change candidate selection criteria input on the fly using, for example, filtering controls 309 to dynamically update a set of selected candidates displayed in the list of selected candidates 308.

Filtering controls 309 can include various filters such as job types, industries, experience, keywords, and tags that can be entered or adjusted by a user to enhance dynamic filtering. In some implementations, the filters can include different types of filters, such as an exclusion filter type or a ranking only filter type. For example, an exclusion filter type may be used to exclude job candidates based on job type or industry, and a ranking filter type may be used to filter candidates based on scores for experience, keywords, and tags.

In the example of FIG. 8, each of the filters can be turned on or off and the sub-filters included in each filter (e.g., software development sub-filter 304) can be removed to update the matching candidates (e.g., candidate match 310) in matching candidates 306. As shown in the example of FIG. 8, all filters in filtering controls 309 have been applied and the list of matching candidates 306 includes matching candidates that each have candidate profiles including the sub-filter term “software development.”

User interface 302 can allow a user to review the list of matching candidates 306 and select candidates to virtually interview, which are then added to selected candidates 308. User interface 302 also allows for the removal of selected candidates.

FIG. 9 is a flowchart for a virtual interview building process that can be performed by interview builder module 54 executed by processor 110 according to an embodiment. In block 214, processor 110 creates a plurality of questions from a predetermined set of question types. As discussed above with reference to FIG. 2, interview builder module 54 receives node input via a user interface of interview builder module 54. The node input can include questions and statements, question keywords, question weights, and keyword weights selected by a user.

The predetermined set of question types may include, for example, a yes/no Boolean question type, a single response question type, a multiple response question type, a ranking question type, and a free-form text response question type. In addition, certain predetermined statement types may also be included as part of interview builder module 54, such as an introductory statement or a closing statement for the virtual interview.

In block 216, processor 110 assigns a weight to each question created in block 214. For example, a user of computer system 106 may set a value to a particular question using an interface of interview builder module 54 (e.g., interface 350 in FIG. 11). Processor 110 may then assign the weight to the question and store the weight in question weights 36.

In block 218, processor 110 determines one or more suggested question keywords to associate with a question using ML trained by a plurality of previous responses and at least one previous question keyword. In some implementations, interview builder module 54 may use NLP in addition to ML to suggest variations or related question keywords in a user interface of interview builder module 54. The ML may be trained from previous campaigns and interview questions using the same or similar question keywords and their associated job candidate responses (e.g., responses 44) to automatically prepopulate suggested question keywords for a question node in the interview builder user interface.

In block 220, processor 110 associates one or more question keywords with each of the plurality of questions created in block 214. The association of question keywords to particular questions may be in response to the selection of suggested keywords or the entering of question keywords by a user in the user interface for interview builder module 54. The associated keywords are stored by processor 110 as question keywords 34 in memory 114.

In block 222, processor 110 assigns a keyword weight to each of the one or more question keywords 34. The weights assigned to question keywords 34 may be in response to input received via the user interface for interview builder module 54. An example of such keyword weighting is shown in user interface 350 of FIG. 11 with keyword weights 372. The assigned keyword weights are stored by processor 110 as keyword weights 38 in memory 114.

In block 224, processor 110 arranges the plurality of questions as nodes in a tree structure representing an order for sending the plurality of questions during the virtual interview. The user interface for interview builder module 54 can allow for the arrangement of questions and statements into the tree structure with different paths depending on the responses to the questions. An example representation of such a tree structure is provided in FIG. 10, which is discussed in more detail below. Processor 110 stores the tree structure as tree structure 40 in memory 114.

FIG. 10 is an example of user interface 312 representing a tree structure for a virtual interview according to an embodiment. User interface 312 may be part of interview builder module 54. As shown in FIG. 10, user interface 312 includes a graphical representation of questions nodes 314, 320, 326, 330, 336, 340, and statement node 344 arranged in a tree structure with different branches depending on the responses to question nodes 326 and 336. The tree structure may be arranged by, for example, dragging nodes and/or adding connectors between nodes in user interface 312.

Question nodes 314, 326, and 336 provide examples of a single response question type. Question nodes 320 and 330 are examples of free-form text response question types that provide for a free-form text field for entering a response. As shown in FIG. 10, question nodes 320 and 330 may also optionally include buttons 324 and 334, respectively, to provide a possible response to the question. In other implementations, buttons to be displayed with a free-form text field may be part of an associated question type node that is displayed with the free-form text field during a virtual interview. Such buttons may provide additional guidance to a job candidate on possible responses, while still allowing the job candidate to type their own response, which can then be analyzed using NLP. In some implementations, the free-form text field may auto-populate with the possible response provided by a selected button.

In the example of FIG. 10, the selection of one of Javascript, Perl, or PHP as a response leads to question node 330 for a follow up question, while selection of one of the remaining response buttons 328 leads to question node 336 bypassing question node 330. Similarly, the selection of one of response buttons 338 in question node 336 leads to either statement node 340 or statement node 344 based on the response selected. Such alternate paths or branches in the tree structure can ordinarily allow for a more focused and interactive virtual interview. In the example of the different paths from question node 326, a recruiter or hiring manager may be more interested in candidates who are proficient in the first three programming languages. The different paths from question node 326 therefore allow for a more specific question about the level of experience a job candidate has in one of these three programming language to better distinguish among the job candidates who consider themselves to be the most proficient in one of the preferred programming languages. More conventional methods of screening of job candidates may require a phone interview to obtain this additional level of information, which would consume more of a recruiter's or hiring manager's time.

Certain nodes such as statement node 340 may also trigger an action performed by virtual interview module 56, such as uploading a file (e.g., a resume) to server 102. After the final statement node 344, the interview interface proceeds to exit at node 348.

FIG. 11 is an example of user interface 350 for a question node of a virtual interview according to an embodiment. User interface 350 may be a part of interview builder module 54. As shown in FIG. 11, user interface 350 includes question type 354, question 352, question fields 356, and question weight 366. In the example of FIG. 11, question type 354 can be changed to a different predetermined question type by selecting an edit question type button. Question 352 can be formed in user interface 350 by typing in a question into a free-form text field or by clicking applicable question fields 356 to automatically populate text for question 352.

The question weight 366 can be set or adjusted in the example of FIG. 11 by using a slider. As noted above, the question weight is used by analytic and ranking module 58 to score a response to the question. In one implementation, the question weight (e.g., 10 for question weight 366 in FIG. 11) can be multiplied by a total keyword weight for the response. Some questions may have a keyword weight set to zero if the question is not used to calculate a score. In this regard, checkbox 364 can allow for a question weight to be set to zero by identifying the question as not participating in ranking.

User interface 350 also provides checkboxes 361, 363, 360, and 358 for different response options. Checkbox 361 can allow for candidate keywords to be extracted or derived from job candidate responses to the question when evaluating the response. Such candidate keywords may be added to a candidate profile 48 stored in memory 114 to collect additional or updated information about a job candidate. In extracting or deriving candidate keywords, analytic and ranking module 58 may use NLP and/or ML to associate relevance to different terms included in the response.

Checkbox 363 provides for a user to enter a hint to the question to help direct a job candidate to provide a more useful response. The selection of checkbox 363 may then allow for a hint on the intent of the question and expected response type, which is displayed below a text box during the virtual interview.

Checkbox 360 provides an option for the evaluation of the response to participate in statistics generated by campaign manager module 52. Such statistics may include, for example, the percentage of job candidates who answered with a certain response for the question. Checkbox 358 further provides for a graph to be displayed by campaign manager module 52 when reviewing results for the question. With reference to the example of FIG. 11, one example can include a bar graph representing the number of job candidates who selected each programming language as their most proficient programming language.

User interface 350 of FIG. 11 further includes question keywords 370, keyword weights 372, alternative keyword 376, and suggested keyword tool 374. In the example of FIG. 11, questions keywords 370 includes eight different programming languages with one of keyword weights 372 assigned to each question keyword. Keyword weights 372 may be selected in user interface 350 by entering a value or sliding a slide-bar to set the weight value for the question keyword, which is stored as part of keyword weights 38 in memory 114. Analytic and ranking module 58 may use the individual keyword weights to calculate a total keyword weight for a response by, for example, summing the keyword weights associated with question keywords matched to a job candidate's response.

In addition, alternative keywords (e.g., alternative keyword 376) can be added to improve the matching of question keywords to responses. The alternative keywords can be manually added by a user under another keyword such as where alternative keyword 376 for “Ruby on Rails” has been added under the “Ruby” question keyword. Analytic and ranking module 58 can then treat the alternative keyword as an instance of the question keyword when evaluating and scoring responses.

Alternative keywords may also be added by using the suggested keyword tool 374. Analytic and ranking module 58 can be used to suggest alternative keywords based on a question keyword 370. In this regard, processor 110 may execute an AI engine to identify alternative keywords by analyzing a plurality of previous responses and at least one previous question keyword stored in campaign data 10 for a different campaign. The plurality of previous responses may be received from different job candidates in response to one or more previous questions not included in interview 28. The use of ML to suggest or generate question keywords can ordinarily allow for a better and more robust matching of job candidate responses to a question.

FIG. 12 is a flowchart for a virtual interview process that can be performed by application 14 executed by processor 110 according to an embodiment. In block 228, an interview hyperlink is sent to a candidate device 108 via network interface 112. The interview hyperlink may be sent, for example, using Instant Messaging and/or an email associated included in a selected job candidate's candidate profile. In some implementations, the interview hyperlink may be associated with a job candidate by using, for example, a unique URL in the hyperlink for the job candidate. The activation of interview interface 17 may then send an indication to server 102 that interview interface 17 has been activated by the job candidate associated with the URL included in the hyperlink. The URL may then be used by server 102 to point to candidate data 10 for the job candidate. In other implementations, another device such as client device 106 may send the hyperlink to the job candidate. In yet other implementations, the activation of interview interface may be accomplished using a login page on a web page hosted by client device 106 or server 102.

In block 230, processor 110 receives an indication that interview interface 17 has been activated by a client device (e.g., client device 106 or a candidate device 108). In some implementations, the interview interface can include a client interface such as a chatbot for enabling a dialog between server 102 and a job candidate operating candidate device 108.

In block 232, processor 110 sends a question included in interview 28 to the client device for access by the job candidate via the interview interface. In most cases, the first question in tree structure 40 will be preceded by an initial statement greeting the job candidate. In more detail, processor 110 sends instructions (e.g., via Javascript) to the client device to display the question via the interview interface, which may be accessed by an application (e.g., web browser 18 in FIG. 1 or a text messaging application) executing on a candidate device 108. Block 232 may include a sub-process for sending instructions to the client device for a particular question type.

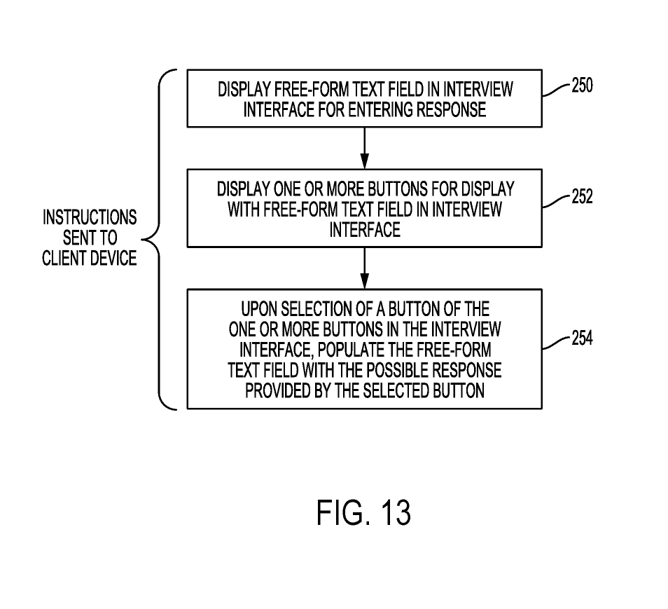

For example, FIG. 13 provides a flowchart for displaying a question type including possible response buttons and a free-form text field at candidate device 108 according to an embodiment. As will be appreciated by those of ordinary skill in the art, blocks 250 to 254 may be performed by sending a single command or set of instructions to the client device, or may involve sending several commands or sets of instructions.

In Block 250 of FIG. 13, processor 110 sends instructions to the client device to display a free-form text field in the interview interface for entering a response. In block 252, processor 110 sends instructions to the client device to display one or more buttons for display with the free-form text field in the interview interface. Each button, as with examples of free-form text question nodes 320 and 330 discussed above for the tree structure of FIG. 10, can provide a possible response to the question. In block 254, the instructions sent to the client device further cause the client device to populate the free-form text field with the possible response provided by the selected button.

Returning to block 234 in the virtual interview process of FIG. 12, processor 110 receives a response to the question sent in block 232 from the client device. Processor 110 then stores the response in block 236. The response may be stored, for example, as part of responses 44 in FIG. 4 for candidate data 12. In some implementations, such stored responses can allow a recruiter or hiring manager to access the responses provided by the job candidate or filter the responses for certain selected candidates for comparison in a user interface of campaign manager module 52. In addition, the stored responses 44 can be used to train ML and NLP to generate suggested keywords (e.g., job description keywords or question keywords) and improve the matching of question keywords to various candidate responses.

As discussed above, each response can be evaluated using analytic and ranking module 58 in real-time as the responses are received during the virtual interview. In this regard, blocks 238 and 240 in FIG. 12 can be performed by processor 110 before sending a next question in a virtual interview session.

In block 238, processor 110 matches one or more question keywords to the response received in block 234. Analytic and ranking module 58 may use NLP and ML in matching question keywords 34 to the response to evaluate the responses in context based on likely meanings inferred by an AI engine used by analytic and ranking module 58. In addition, the use of NLP can improve the matching of question keywords to responses by identifying alternative spellings, alternative vocabulary, and misspellings.

In block 240, processor 110 calculates a score for the received response based on a question weight (e.g., from question weights 36 in FIG. 3) and one or more keyword weights (e.g., from keyword weights 38 in FIG. 3) associated with the matched one or more question keywords. In some implementations, analytic and ranking module 58 may calculate the score for the response by multiplying the question weight by a total keyword score for the response that is based on the keyword weights assigned to the matched question keywords.

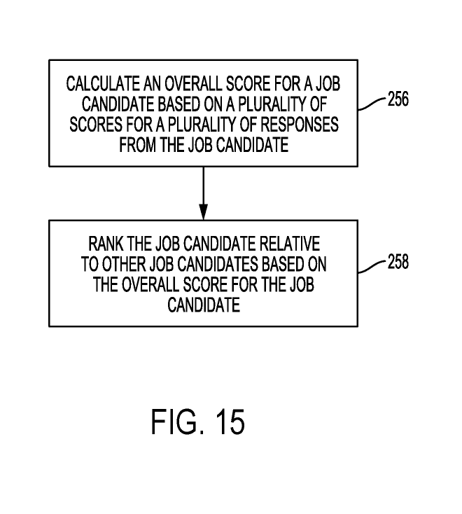

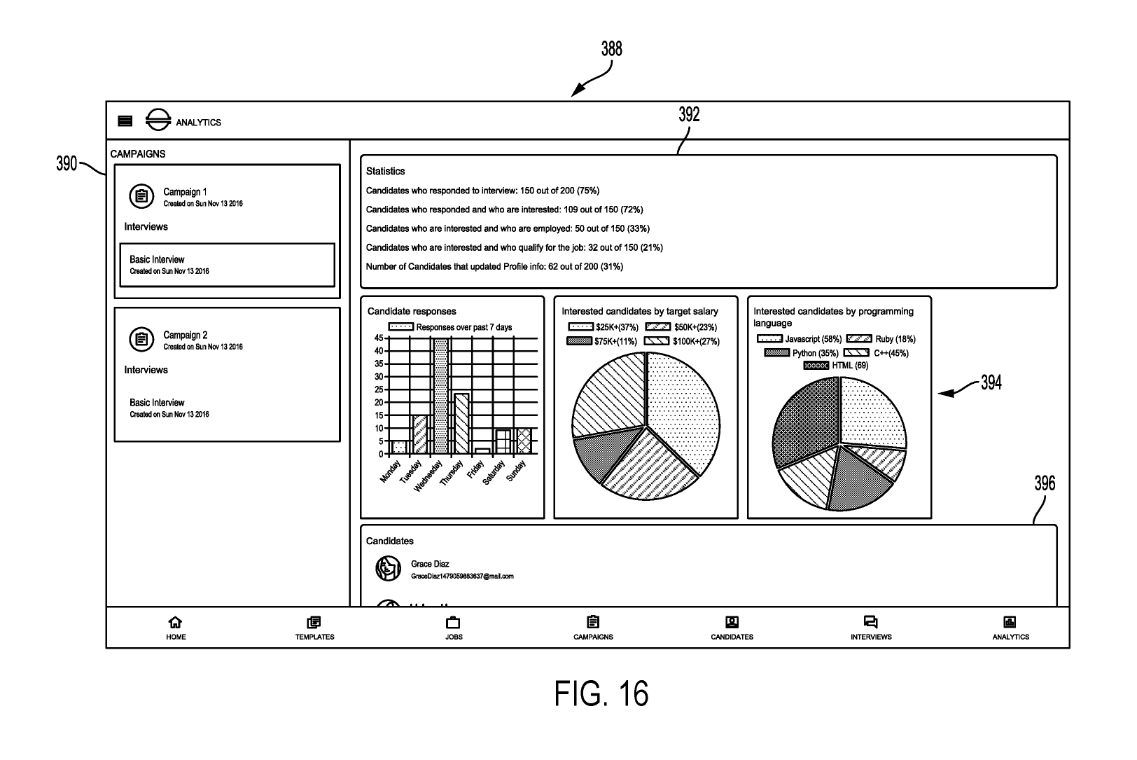

In block 242, processor 110 stores the score calculated in block 240 for the response in memory 114. The score for the response may be stored, for example, as part of candidate scores 42 in FIG. 4 of candidate data 12. As discussed in more detail below with reference to FIGS. 15 and 16, the individual response scores and the overall score for a candidate may be used for filtering and/or ranking job candidates using campaign manager module 52.

In block 244, if it is determined that the last question in a branch of the tree structure for the virtual interview has been reached, the process of FIG. 12 proceeds to block 246 to send a final node or nodes to the client device for access by the job candidate via the interview interface. On the other hand, if it is determined that the last question in a branch has not been reached in block 244, the process continues to block 248 to select a next question in real-time based on the evaluation of the current response if there is more than one branch from the current question node. In the example of the tree structure represented in FIG. 10 discussed above, such a selection would be made when evaluating a response to question node 326 since question node 326 is not the last question in the branch and there is more than one path from question node 326. The real-time evaluation of responses with a tree structure for the virtual interview can allow for more relevant information to be gathered during the screening process without significantly adding to the time needed for screening a large pool of job candidates.

In cases where there is only one path from the current question node, block 248 may be omitted or the next question in the branch is automatically selected.

The virtual interview process of FIG. 12 then returns back to block 232 to send the next question (e.g., a second question) to the client device. Blocks 232 to 242 may then repeat until it is determined in block 244 that the last question in the branch has been reached.

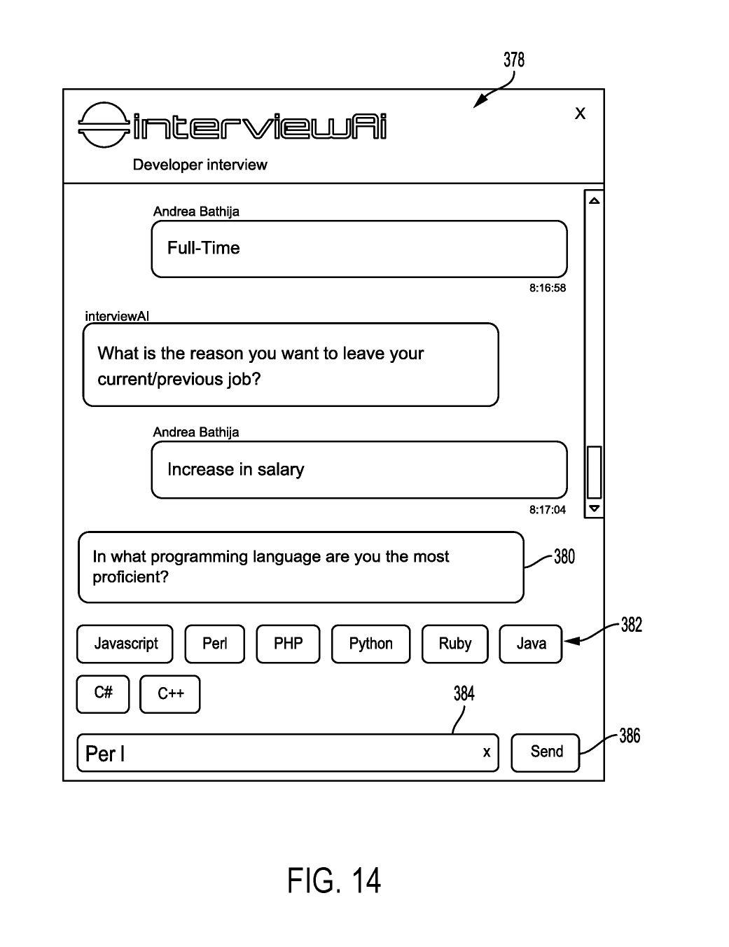

FIG. 14 is an example of an interview interface displayed at a candidate device 108 or another client device according to an embodiment. As shown in FIG. 14, interview interface 378 includes questions and answers to facilitate a dialog between the job candidate and server 102. The example of FIG. 14 shows an interview interface that can be displayed using a web browser or a texting application, or other messaging application, such as Facebook's messenger application.

In the example interface of FIG. 14, a current question 380 is displayed with response buttons 382 and free-form text field 384. A job candidate may enter their response by using buttons 382, by entering their response into free-form text field 384, or a combination of both. In this regard, selecting buttons 382 can add the text from the button to free-form text field 384. In some implementations, the selection of the button automatically sends the response provided by the button. In other implementations, the free-form text field 384 is populated with the response and the job candidate can edit the response before pressing the send button 386 or hitting enter to submit their response. Buttons 382 can ordinarily allow for a job candidate to more easily and/or more quickly complete the virtual interview.

In addition, some implementations of the interview interface dynamically use NLP and/or ML as text is entered into free-form text field 384. Interview interface 378 may then highlight or otherwise change the color of a button of buttons 382 that most likely corresponds to the text entered by the job candidate. This visual indication can provide the job candidate a sense of which question keyword their response will be associated with before their response is submitted by pressing send button 386.

FIG. 15 is a flowchart for a scoring and ranking process that can be performed by processor 110 executing analytic and ranking module 58 of application 14 according to an embodiment. The process of FIG. 15 may optionally be performed at different times throughout a hiring campaign to provide a current ranking of job candidates or at the completion of a certain number of virtual interviews by selected candidates.

In block 256, processor 110 calculates an overall score for a job candidate based on a plurality of scores for a plurality of responses from the job candidate. The overall score may be based on question weights and keyword weights associated with question keywords determined to match the responses.

In block 258, processor 110 ranks the job candidate relative to other job candidates based on the overall score calculated in block 256. This information may be presented to a user in a user interface of campaign manager module 52 or analytic and ranking module 58.

FIG. 16 is an example of a user interface 388 for campaign manager module 52 according to an embodiment. In other implementations, user interface 388 may alternatively be provided by analytic and ranking module 58. As shown in FIG. 16, user interface 388 includes a list of campaigns 390, statistics 392, candidates 396, and graphs 394 to graphically present information collected from virtual interviews and/or candidate data 12. Statistics 392 can include information related to the campaign in general, such as the number of responses for each day in the past week or the number of candidates who have responded to an interview hyperlink so far. Statistics 392 can also include more candidate specific information based on interview responses and candidate data 12, such as the number of job candidates who indicated they are interested in the job and also meet certain job qualifications. Other examples can include various other statistics.

Graphs 394 in FIG. 16 include several examples of representing campaign data 10 and candidate data 12 graphically. The graphs can include charts (e.g., a pie chart, a bar graph, or curve plots) based on the responses currently collected for specific questions in interview 28. For example, the pie charts shown in FIG. 16 provide a graphic representation of responses to questions related to a programming language proficiency and a target salary. The graphic representation of responses for a particular question can be set, for example, in user interface 350 of FIG. 11 by selecting the display graph checkbox 358.

Candidates 396 can include a list of selected candidates for the virtual interview. This list can be searchable and may also be used in some implementations to link to more information about the candidate, such as how they answered a particular question or their exact response, as stored during a virtual interview. These tools can ordinarily allow a user of client device 106 to easily review a current campaign while it is in progress and quickly retrieve more detailed information about a candidate as needed.

In addition, and as described above, the use of NLP and ML can make the screening process more accurate, useful, and robust by providing better matching of question keywords to responses on a question by question basis. Moreover, the virtual interview processes described above ordinarily allow for a more dynamic and up-to-date screening of job candidates that can elicit more information than a search of static information (e.g., resumes and job applications). The virtual interview processes described above are also scalable in the sense that additional job candidates can be interviewed without costing a recruiter or hiring manager additional time.

### Other Embodiments

Those of ordinary skill in the art will appreciate that the various illustrative logical blocks, modules, and processes described in connection with the examples disclosed herein may be implemented as electronic hardware, computer software, or combinations of both. Furthermore, the foregoing processes can be embodied on a computer readable medium which causes a processor or computer to perform or execute certain functions.

To clearly illustrate this interchangeability of hardware and software, various illustrative components, blocks, and modules have been described above generally in terms of their functionality. Whether such functionality is implemented as hardware or software depends upon the particular application and design constraints imposed on the overall system. Those of ordinary skill in the art may implement the described functionality in varying ways for each particular application, but such implementation decisions should not be interpreted as causing a departure from the scope of the present disclosure.

The various illustrative logical blocks, units, modules, and controllers described in connection with the examples disclosed herein may be implemented or performed with a general purpose processor, a DSP, an ASIC, a FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The activities of a method or process described in connection with the examples disclosed herein may be embodied directly in hardware, in a software module executed by a processor, or in a combination of the two. The steps of the method or algorithm may also be performed in an alternate order from those provided in the examples. A software module may reside in RAM memory, flash memory, ROM memory, EPROM memory, EEPROM memory, registers, hard disk, a removable media, an optical media, or any other form of storage medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC).

The foregoing description of the disclosed example embodiments is provided to enable any person of ordinary skill in the art to make or use the embodiments in the present disclosure. Various modifications to these examples will be readily apparent to those of ordinary skill in the art, and the principles disclosed herein may be applied to other examples without departing from the spirit or scope of the present disclosure. The described embodiments are to be considered in all respects only as illustrative and not restrictive and the scope of the disclosure is, therefore, indicated by the following claims rather than by the foregoing description. All changes which come within the meaning and range of equivalency of the claims are to be embraced within their scope.

What is claimed is:

1. A method of screening a job candidate using a server, the method comprising:
receiving an indication that an interview interface has been activated by a client device;
sending a first question of a plurality of questions to the client device for access by the job candidate via the interview interface;
receiving a first response to the first question from the client device; and
evaluating the first response in real-time using the server before sending a second question of the plurality of questions to the client device for access by the job candidate via the interview interface.

2. The method of claim 1, further comprising:
assigning a question weight to the first question;
associating one or more question keywords with the first question; and
assigning a keyword weight to each of the one or more question keywords associated with the first question.

3. The method of claim 2, further comprising determining one or more suggested keywords to associate with a question of the plurality of questions using Machine Learning (ML) by analyzing a plurality of previous responses and at least one previous question keyword, wherein the plurality of previous responses is received from different job candidates.

4. The method of claim 2, further comprising evaluating the first response in real-time by:
matching one or more question keywords to the first response; and
calculating a score for the first response based on the question weight and one or more keyword weights associated with the one or more question keywords matched to the first response.

5. The method of claim 4, further comprising matching a question keyword to the first response using Natural Language Processing (NLP) by identifying a variation of the question keyword or a term related to the question keyword in the first response.

6. The method of claim 1, further comprising:
storing the first response in a memory of the server; and
storing a score for the first response in the memory.

7. The method of claim 1, further comprising assigning a question weight of zero to a question of the plurality of questions so that a response to the question does not contribute to a score for the job candidate.

8. The method of claim 1, wherein the plurality of questions is arranged as nodes in a tree structure representing an order for sending the plurality of questions to the client device, and wherein the method further comprises selecting a next question in the tree structure in real-time from among at least one other question in the tree structure based on the evaluation of a current response received from the client device.

9. The method of claim 1, further comprising creating the plurality of questions from a predetermined set of question types including at least two of a yes/no Boolean question type, a single response question type, a multiple response question type, a ranking question type, and a free-form text response question type.

10. The method of claim 1, wherein the interview interface includes a client interface enabling a dialog between the server and a candidate device operated by the job candidate.

11. The method of claim 1, wherein the interview interface is configured to be executed on the client device and accessed by a web browser executed on a candidate device operated by the job candidate.

12. The method of claim 1, further comprising calculating an overall score for the job candidate based on a plurality of scores for a plurality of responses from the job candidate.

13. The method of claim 12, wherein each score of the plurality of scores is calculated in real-time such that the score for the first response is calculated before sending the second question to the client device.

14. The method of claim 12, further comprising ranking the job candidate relative to other job candidates based on the overall score for the job candidate.

15. The method of claim 1, further comprising sending an interview hyperlink to a candidate device operated by the job candidate, the interview hyperlink pointing to a web page served by the client device, and wherein the client device is configured to activate the interview interface in response to the candidate device accessing the web page via the hyperlink.

16. The method of claim 15, wherein the interview hyperlink includes a Uniform Resource Locator (URL) associated with the job candidate in a memory of the server.

17. The method of claim 1, wherein the client device is operated by the job candidate.

18. A server for screening a job candidate, the server comprising:
a network interface for communicating with a client device via a network;
a memory for storing a plurality of questions for interviewing the job candidate; and
a processor configured to:
receive an indication that an interview interface has been activated by a client device;
send a first question of the plurality of questions to the client device for access by the job candidate via the interview interface;
receive a first response to the first question from the client device; and
evaluate the first response in real-time before sending a second question to the client device for access by the job candidate via the interview interface.

19. The server of claim 18, wherein the processor is further configured to:
assign a question weight to the first question;
associate one or more question keywords with the first question; and
assign a keyword weight to each of the one or more question keywords associated with the first question.

20. The server of claim 19, wherein the processor is further configured to determine one or more suggested keywords to associate with a question of the plurality of questions using Machine Learning (ML) by analyzing a plurality of previous responses and at least one previous question keyword stored in the memory, wherein the plurality of previous responses is received from different job candidates.

21. The server of claim 18, wherein the processor is further configured to:
match one or more question keywords to the first response; and
calculate a score for the first response based on the question weight and one or more keyword weights associated with the one or more question keywords matched to the first response.

22. The server of claim 21, wherein the processor is further configured to match a question keyword to the first response using Natural Language Processing (NLP) by identifying a variation of the question keyword or a term related to the question keyword in the first response.

23. The server of claim 18, wherein the processor is further configured to:
store the first response in the memory; and
store a score for the first response in the memory.

24. The server of claim 18, wherein the processor is further configured to assign a question weight of zero to a question of the plurality of questions so that a response to the question does not contribute to a score for the job candidate.

25. The server of claim 18, wherein the plurality of questions is arranged as nodes in a tree structure representing an order for sending the plurality of questions to the client device, and wherein the processor is further configured to select a next question in the tree structure in real-time from among at least one other question in the tree structure based on the evaluation of a current response received from the client device.

26. The server of claim 18, wherein the processor is further configured to create the plurality of questions from a predetermined set of question types including at least two of a yes/no Boolean question type, a single response question type, a multiple response question type, a ranking question type, and a free-form text response question type.

27. The server of claim 18, wherein the interview interface includes a client interface configured to enable a dialog between the server and a candidate device operated by the job candidate.

28. The server of claim 18, wherein the interview interface is configured to execute on the client device for access by a web browser executed on a candidate device operated by the job candidate.

29. The server of claim 18, wherein the processor is further configured to calculate an overall score for the job candidate based on a plurality of scores for a plurality of responses from the job candidate.

30. The server of claim 29, wherein the processor is further configured to calculate in real-time each score of the plurality of scores such that the score for the first response is calculated before sending the second question to the client device.

31. The server of claim 30, wherein the processor is further configured to rank the job candidate relative to other job candidates based on the overall score for the job candidate.

32. The server of claim 18, wherein the processor is further configured to send an interview hyperlink to a candidate device operated by the job candidate, the interview hyperlink pointing to a web page served by the client device, and wherein the client device activates the interview interface in response to the candidate device accessing the web page via the hyperlink.

33. The server of claim 32, wherein the interview hyperlink includes a Uniform Resource Locator (URL) associated with the job candidate in the memory.

34. The server of claim 18, wherein the client device is operated by the job candidate.

35. A non-transitory computer-readable medium storing computer-executable instructions for screening a job candidate, wherein when the computer-executable instructions are executed by a processor of a server, the computer-readable instructions cause the processor to:
receive an indication that an interview interface has been activated by a client device;
send a first question of a plurality of questions stored in a memory of the server to the client device for access by the job candidate via the interview interface;
receive a first response to the first question from the client device; and
evaluate the first response in real-time before sending a second question to the client device for access by the job candidate via the interview interface.
